(19) United States
(12) Patent Application Publication
(10) Pub. No.: US 2006/0010474 A1
(43) Pub. Date: Jan. 12, 2006

(54) Television broadcast receiver

(75) Inventor: Keisuke Tsukamoto, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co. Ltd., Daito-shi (JP)

(21) Appl. No.: 11/175,263

(22) Filed: Jul. 7, 2005

(30) Foreign Application Priority Data
Jul. 8, 2004 (JP) 2004-201707

(51) Int. Cl. H04N 5/50; H04N 7/20

(52) U.S. Cl. 725/72; 348/570

(57) ABSTRACT

A television receiver comprises a tuner connected to a unidirectional antenna or a multi-directional antenna, and a microprocessor for controlling a reception process of the television receiver. The microprocessor outputs, to the connected antenna, a receiving direction control signal for commanding a receiving direction, and determines, on the basis of signal intensities of the television signal received by the tuner, which antenna is connected to the tuner. If the microprocessor determines that the unidirectional antenna is connected to the tuner, the microprocessor outputs, to the tuner, a channel control signal to command the tuner for a channel to be selected, while if the microprocessor determines that the multi-directional antenna is connected to the tuner, the microprocessor outputs, to the tuner, both the channel control signal and the receiving direction control signal. This television receiver can properly perform its television signal reception processes, depending on the kind of antenna connected thereto.

### BACKGROUND OF THE INVENTION

1. Field of the Invention

The present invention relates to a television broadcast receiver for receiving terrestrial broadcasts.

2. Description of the Related Art

Conventionally, directional antennas such as a Yagi antenna are used to receive terrestrial broadcasts. A directional antenna has a high directivity to be able to receive a weak radio wave or signal. At the same time, the directional antenna has a drawback that it can receive only a radio wave coming from one direction. This is not a problem in countries like Japan where broadcast towers are concentrated in one location. However, in countries like the United States of America, there are many areas where broadcast towers spread around cities. If a directional antenna such as a Yagi antenna is used in such case, it may occur that the directional antenna cannot receive many broadcasts from broadcast towers even if the directional antenna is placed close to the broadcast towers.

In order to solve such problem, the EIA (Electronic Industries Association)-909 standard “Antenna Control Interface” was instituted, which provides a technology that a television broadcast receiver can control and change receiving directions of the antenna. More specifically, it is a standard to connect, to a television broadcast receiver, a so-called smart antenna which is capable of changing its receiving directions, and to control the antenna by the television broadcast receiver via a modular terminal. In the present specification, the two kinds of antennas are distinguished by referring to the directional antenna, such as the Yagi antenna, as a unidirectional antenna, and by referring to the antenna, capable of changing its receiving directions, as a multi-directional antenna.

There is a possibility that a unidirectional antenna is connected to a television broadcast receiver, to which a multi-directional antenna should be connected. If the television broadcast receiver does not discriminate which antenna is connected thereto, the television broadcast receiver connected to a unidirectional antenna may possibly perform control the same as that to be performed for a multi-directional antenna. For example, some of such television broadcast receivers have an omni-directional scanning function to sequentially command all the receiving directions of a multi-directional antenna for an arbitrary channel selected by a user, and to automatically determine a receiving direction, which enables television broadcast signal reception in a best receiving condition for the channel, on the basis of e.g. signal intensities of a television broadcast signal of the channel in all the receiving directions. Such receiving direction to enable the best receiving condition is referred to as best receiving direction in the present specification.

This omni-directional scanning process is a completely unnecessary process for a unidirectional antenna, which is incapable of changing its receiving direction. The omni-directional scanning process, when performed for the unidirectional antenna, is a waste of time. Accordingly, it is necessary or desired to perform the omni-directional scanning process only in the case where the television broadcast receiver is connected to the multi-directional antenna.

### SUMMARY OF THE INVENTION

An object of the present invention is to provide a television broadcast receiver that can properly perform a process for receiving a television broadcast signal, depending on the kind of antenna connected the television broadcast receiver.

According to a first aspect of the present invention, we provide a television broadcast receiver comprising: a tuner connected to a unidirectional antenna having a single receiving direction, or to a multi-directional antenna having a predetermined number of receiving directions, for receiving a television broadcast signal; and a microprocessor for controlling a reception process of the television broadcast receiver to receive the television broadcast signal. For performing the reception process of the television broadcast receiver, the microprocessor outputs, to the multi-directional antenna or the unidirectional antenna, a receiving direction control signal for commanding a receiving direction to receive the television broadcast signal, and determines, on the basis of signal intensities of the television broadcast signal received by the tuner, whether the unidirectional antenna or the multi-directional antenna is connected to the tuner.

If the microprocessor determines that the unidirectional antenna is connected to the tuner, the microprocessor controls to output, to the tuner, a channel control signal to command the tuner for a channel to be selected, while if the microprocessor determines that the multi-directional antenna is connected to the tuner, the microprocessor controls to output, to the tuner, the channel control signal and the receiving direction control signal.

The television broadcast receiver according to the first aspect and the later described second aspect of the present invention can properly perform its television broadcast signal reception processes, depending on the kind of antenna connected thereto.

Preferably, the microprocessor sequentially outputs, to the multi-directional antenna or the unidirectional antenna, the receiving direction control signal to sequentially command receiving directions of the multi-directional antenna, and further commands the tuner to measure signal intensities of the received television broadcast signal which correspond to the respective receiving directions, wherein if the measured signal intensities corresponding to the respective receiving directions are substantially the same as each other, the microprocessor determines that the unidirectional antenna is connected to the tuner, while if at least one of the measured signal intensities is significantly different from another or others, the microprocessor determines that the multi-directional antenna is connected to the tuner.

It is possible that the number of receiving directions of the multi-directional antenna is sixteen.

According to a second aspect of the present invention, we provide a television broadcast receiver comprising: a signal receiving means connected to a unidirectional antenna having a single receiving direction, or to a multi-directional antenna having a predetermined number of receiving directions, for receiving a television broadcast signal; and a reception control means for controlling a reception process of the television broadcast receiver to receive the television broadcast signal. For performing the reception process of the television broadcast receiver, the reception control means outputs, to the multi-directional antenna or the unidirectional antenna, a receiving direction control signal for commanding a receiving direction to receive the television broadcast signal, and determines, on the basis of signal intensities of the television broadcast signal received by the signal receiving means, whether the unidirectional antenna or the multi-directional antenna is connected to the signal receiving means.

If the reception control means determines that the unidirectional antenna is connected to the signal receiving means, the reception control means controls to output, to the signal receiving means, a channel control signal to command the signal receiving means for a channel to be selected, while if the reception control means determines that the multi-directional antenna is connected to the signal receiving means, the reception control means controls to output, to the signal receiving means, the channel control signal and the receiving direction control signal.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic view showing a situation in which a TV (television) broadcast receiver in a general home of a user receives digital TV broadcast signals from broadcast towers located in various zones;

FIG. 2 is a schematic block diagram showing a TV broadcast receiver according to an embodiment of the present invention;

FIG. 3 is a chart showing and explaining multiple receiving directions of a smart antenna connected to the TV broadcast receiver;

FIG. 4 is a flow chart showing a channel information table creating process performed by the TV broadcast receiver;

FIG. 5 is a flow chart showing an antenna discrimination process performed by the TV broadcast receiver;

FIG. 6 is a flow chart showing a one-channel omni-directional scanning process performed by the TV broadcast receiver;

FIG. 7 is a flow chart showing an all-channel omni-directional scanning process performed by the TV broadcast receiver;

FIG. 8A is a schematic view showing an example of a channel information table created by the all-channel omni-directional scanning process;

FIG. 8B is a schematic view showing an example of a channel information table created by an all-channel unidirectional scanning process performed by the TV broadcast receiver;

FIG. 9 is a flow chart showing the all-channel unidirectional scanning process; and

FIG. 10 is a flow chart showing a reception process performed by the TV broadcast receiver for receiving a TV broadcast signal.

### DESCRIPTION OF THE PREFERRED EMBODIMENTS

The best modes and preferred embodiments of the present invention will be described hereinafter with reference to the annexed drawings. Note that the specific embodiments described are not intended to cover the entire scope of the present invention, and hence the present invention is not limited to only the specific embodiments.

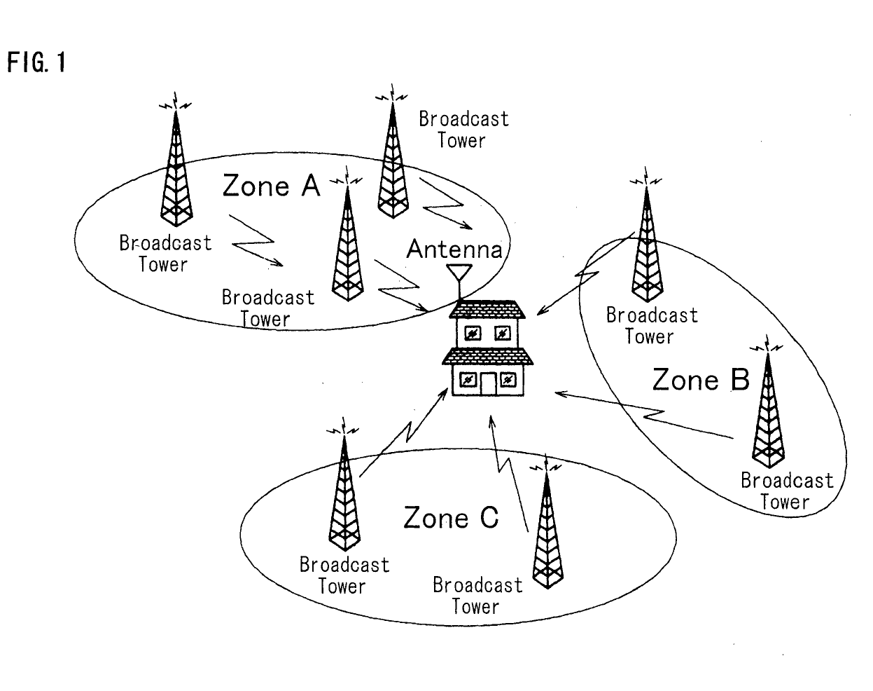

FIG. 1 is a schematic view showing a situation in which a television broadcast receiver in a general home of a user receives digital television (TV) broadcast signals (hereafter referred to simply as “TV broadcast signals”) of broadcast stations transmitted from broadcast towers located in various zones. Generally, if a TV broadcast receiver receives TV broadcast signals which have signal intensity equal to or higher than a predetermined threshold value, it is possible to obtain images of a certain quality or higher, using error correction and the like. Here, it is assumed that as shown in FIG. 1, the TV broadcast receiver in the home of the user can receive TV broadcast signals transmitted from broadcast towers spreading across multiple locations e.g. in zone A, zone B and zone C, thereby making it possible for the user to view TV programs from the broadcast stations. A multi-directional antenna, called a smart antenna, having multiple receiving directions is put to practical use for such situation.

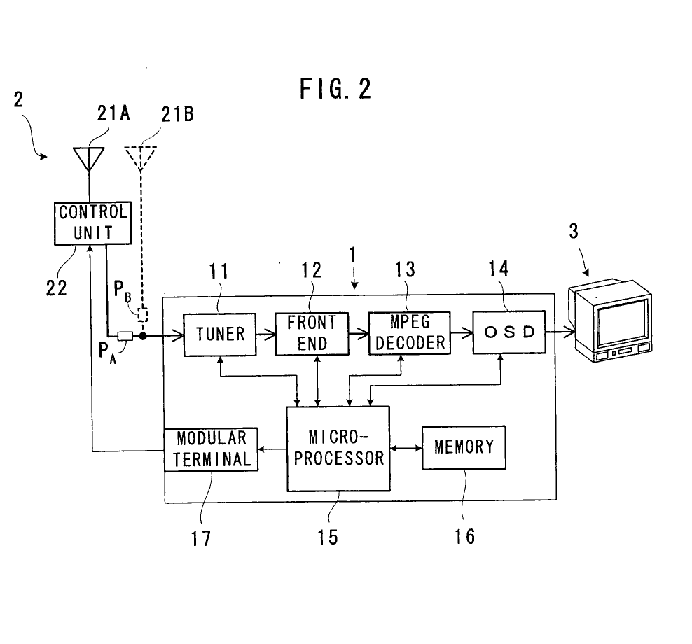

FIG. 2 is a schematic block diagram showing a TV broadcast receiver 1 according to an embodiment of the present invention. Referring to FIG. 2, the TV broadcast receiver 1 comprises a tuner (signal receiving means) 11 connected to a smart antenna (multi-directional antenna) 2, having an antenna unit 21A and a control unit 22, via a plug PA or a unidirectional antenna 21B (shown by dotted line) having a single receiving direction such as a Yagi-antenna via a plug PB for receiving a TV broadcast signal. When the control unit 22 of the smart antenna 2 is plugged in the plug PA by e.g. a user, the control unit 22 is connected via the plug PA to the tuner 11, while when the unidirectional antenna 21B is plugged in the plug PB by e.g. the user, the unidirectional antenna 21B is connected via the pug PB to the tuner 11. The present embodiment is based on an assumption that either the smart antenna 2 or the unidirectional antenna 21B is connected to the tuner 11 by e.g. the user via the plug 2A or the plug 2B.

When the TV broadcast receiver 1 is connected to the smart antenna 2 having multiple receiving directions, the TV broadcast receiver 1 switches an active receiving direction of the smart antenna 2 (namely, makes one of the multiple receiving directions of the smart antenna 2 active) so as to receive a TV broadcast signal transmitted in a given frequency band from one of the broadcast towers spreading across the multiple locations, and to output a TV program contained in the TV broadcast signal in each channel to a monitor 3. Note that in the present embodiment, a physical channel that is a frequency band of carrier wave used for a TV program is referred to simply as “channel”.

The TV broadcast receiver 1 further comprises: a front end 12 for subjecting the TV broadcast signal received by the tuner 11 to predetermined signal processing, and decoding the received TV broadcast signal; an MPEG (Motion Picture Experts Group) decoder 13 for decoding the TV broadcast signal which is an MPEG-compressed signal; an on-screen display (OSD) signal superimposer 14 for superimposing a signal of a predetermined display image on the decoded TV broadcast signal; a microprocessor (reception control means) 15 for outputting, to the tuner 11, a channel control signal to command a channel to select, and for outputting, to the smart antenna 2, a receiving direction control signal to command a receiving direction for receiving the TV broadcast signal so as to control an entire process of receiving the TV broadcast signal; a memory 16 for storing a channel information table; a modular terminal 17; and so on.

The TV broadcast signal decoded by the MPEG decoder 13 is output to the monitor 3 via the OSD signal superimposer 14 for display. The microprocessor 15 controls the entire TV broadcast receiver 1, and serves as an antenna discriminating means, a one-channel omni-directional scanning means, an all-channel omni-directional scanning means and a all-channel unidirectional scanning means for performing an antenna discriminating process, a one-channel omni-directional scanning process (i.e. omni-directional scanning process for one channel), an all-channel omni-directional scanning process (i.e. omni-directional scanning process for all channels) and an all-channel unidirectional scanning process (i.e. unidirectional scanning process for all channels), respectively, as will be described later.

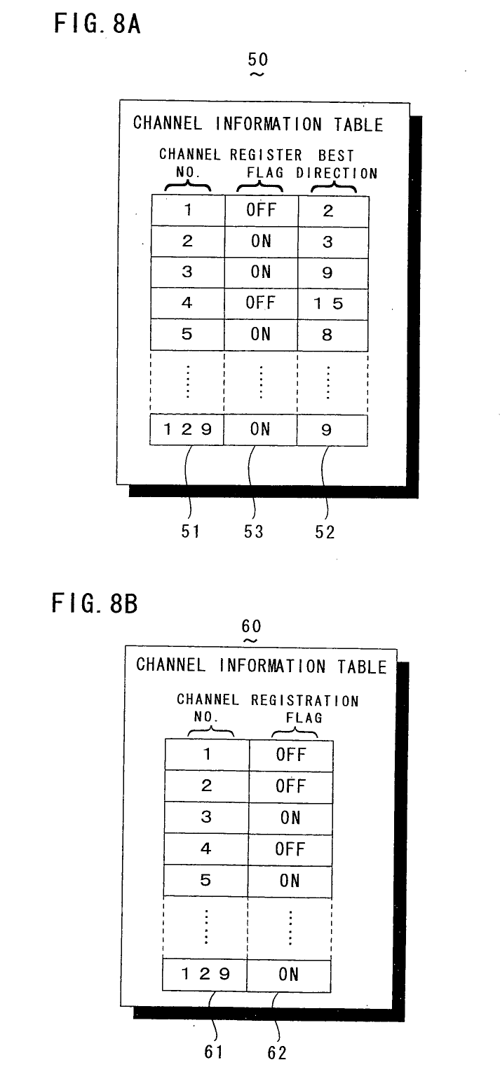

As will also be described later with reference to FIG. 8A, the channel information table stored in the memory 16 contains: channel numbers of respective channels transmitted from the broadcast stations via the broadcast towers; best receiving directions of the smart antenna 2 for receiving TV broadcast signals of the respective channels; and registration flags indicating whether the respective channels are registered as selectable channels, or registered as non-selectable channels. Based on the registration flags, the microprocessor 15 performs a reception process for receiving TV broadcast signals of the channels which are registered therein as the selectable channels. The microprocessor 15 reads, from the memory 16, the best receiving direction of a channel to be selected. The microprocessor 15 further outputs, to the smart antenna 2, a receiving direction control signal to command the best receiving direction for the selected channel so as to perform the reception process. In the descriptions below, the state where a channel is registered as a selectable channel is referred to as “on-state of registration flag” or “registration flag on”, while the state where a channel is registered as a non-selectable channel is referred to as “off-state of registration flag” or “registration flag off”.

The memory 16 further stores an antenna management file for managing setting of an antenna connected to the tuner 11. The antenna management file contains at least information to identify the kind of antenna used by being connected to the tuner 11 (such antenna being hereafter referred to as “used antenna”). Based on such information, the microprocessor 15 controls an antenna connected to the tuner 11.

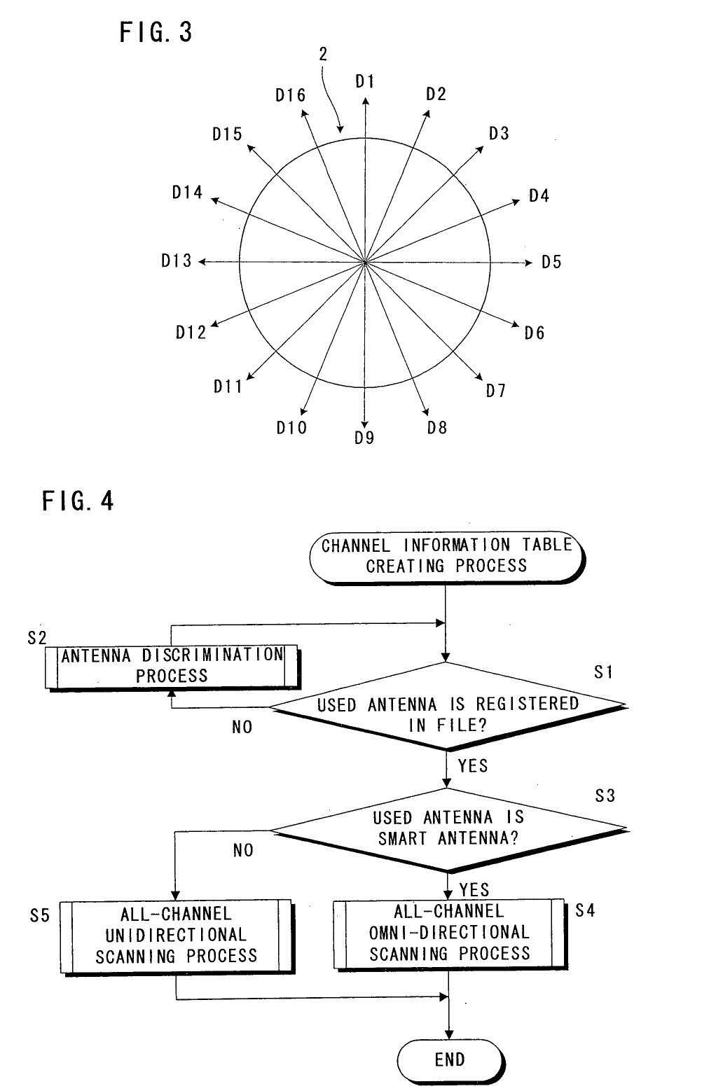

FIG. 3 is a chart showing and explaining multiple receiving directions of the smart antenna 2. When connected to the smart antenna 2, the TV broadcast receiver 1 according to the present embodiment receives, and measures receiving conditions of, TV broadcast signals coming from sixteen receiving directions provided in the EIA-909 standard as indicated by D1 to D16 in FIG. 3, respectively. The smart antenna 2 comprises: an antenna unit 21A for receiving TV broadcast signals from the sixteen receiving directions D1 to D16 by mechanically or electronically switching an active receiving direction (namely, making one of the multiple receiving directions active); and a control unit 22 for controlling the operation of the antenna unit 21A. Based on the receiving direction control signal from the TV broadcast receiver 1, the control unit 22 makes active one of the multiple receiving directions D1 to D16 of the antenna unit 21A which is commanded by the receiving direction control signal.

Next, referring to the flow chart of FIG. 4, a channel information table creating process for creating a channel information table will be described. When commanded by a user to create a channel information table (or automatically if no channel information table is registered yet), the microprocessor 15 determines whether or not a used antenna is registered in an antenna management file (S1). If a used antenna is not registered in the antenna management file (NO in S1), the microprocessor 15 performs a later described antenna discrimination process so as to discriminate the kind of antenna connected to the tuner 11 (S2), and registers, in the antenna management file, the kind of antenna thus having been discriminated. On the other hand, if a used antenna is registered in the antenna management file (YES in S1), the microprocessor 15 determines whether or not the used antenna registered therein is a smart antenna 2 (S3). If the used antenna registered therein is the smart antenna 2 (YES in S3), the microprocessor 15 performs a later described all-channel omni-directional scanning process so as to renew a channel information table (designated by reference numeral 50 in FIG. 8A) (S4). On the other hand, if the used antenna registered therein is a unidirectional antenna 21B, not a smart antenna 2, the microprocessor 15 performs a later described all-channel unidirectional scanning process so as to renew a channel information table (designated by reference numeral 60 in FIG. 8B) (S5).

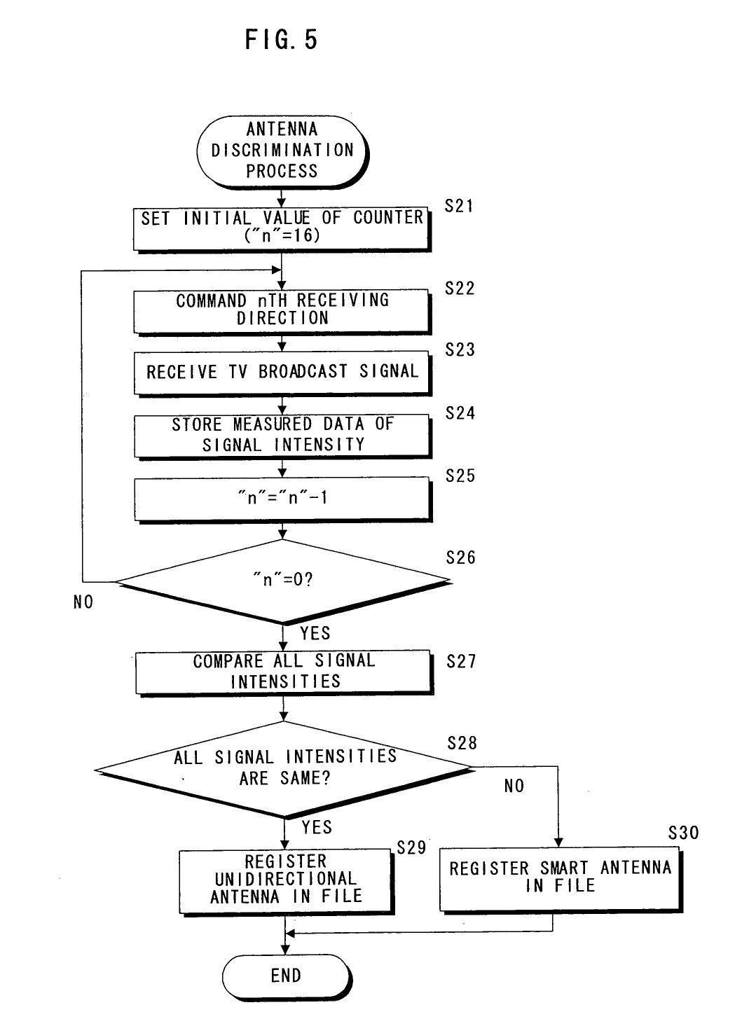

Referring now to the flow chart of FIG. 5, an antenna discrimination process will be described. When the antenna discrimination process starts, the microprocessor 15 sets an initial value n of a counter (the value n being “16” as an example in the present embodiment) according to the number of receiving directions of an assumed smart antenna 2 (S21). The microprocessor 15 then outputs a receiving direction control signal to the antenna to command an nth receiving direction (S22). The tuner 11 receives a TV broadcast signal of a channel selected after a predetermined receiving direction switching time, which the smart antenna 2 requires in order to switch the receiving direction from the time the microprocessor 15 outputs the receiving direction control signal (S23). The microprocessor 15 commands the tuner 11 to measure signal intensity of the received TV broadcast signal, and stores data of the measured signal intensity in the memory 16 (S24).

The microprocessor 15 sequentially outputs, to the antenna at given time intervals, the receiving direction control signal to sequentially command all the receiving directions of the antenna so as to sequentially make measurements as follows. The microprocessor 15 decrements the counter by one (S25), and determines whether the tuner 11 has measured the signal intensities of the TV broadcast signal in all the receiving directions (S26). If the tuner 11 has not measured the signal intensities of the TV broadcast signal in all the receiving directions (NO in S26), the microprocessor 15 goes back to the step S22, and commands the tuner 11 to measure the signal intensity or intensities of the TV broadcast signal not having been measured (more specifically measure the signal intensity of the TV broadcast signal in each subsequent receiving direction until completion). If the TV broadcast signal receiver 1, more specifically the tuner 11, completes the measurements of the signal intensities of the TV broadcast signal for all the receiving directions (YES in S26), so that the memory 16 stores all the measured data of signal intensities, the microprocessor 15 reads and compares the measured data stored in the memory 16 (S27), and further determines whether or not the signal intensities in all the receiving directions are substantially the same as each other (S28).

The mechanism for determining which one of the smart antenna 2 and the unidirectional antenna 21B is connected to the tuner 11 is described as follows. If the antenna connected to the tuner 1 is a unidirectional antenna 21B, which is incapable of changing its receiving direction or directivity, the receiving direction or directivity of the antenna is always constant, regardless of the presence or absence of the command by the receiving direction control signal. Accordingly, the signal intensities of the TV broadcast signal, which are received corresponding to respective receiving directions, or more specifically in response to the commands of the microprocessor 15 for respective receiving directions using the receiving direction control signal, are substantially the same as each other. On the other hand, if the antenna connected to the tuner 11 is a smart antenna 2, which is capable of changing its receiving direction or directivity, the receiving direction or directivity of the antenna changes in response to the commands of the microprocessor 15 using the receiving direction control signal. Accordingly, by comparing the signal intensities measured in the multiple receiving directions, it is possible to determine whether the unidirectional antenna 21B or the smart antenna 2 is connected to the tuner 11.

Thus, if the signal intensities of the TV broadcast signal in all the receiving directions are substantially the same as each other (YES in S28), the microprocessor 15 determines on the basis of the above mechanism that the kind of antenna connected to the tuner 11 is the unidirectional antenna 21B, and registers the unidirectional antenna 21B as the used antenna in the antenna management file (S29). On the other hand, if the signal intensities of the TV broadcast signal in the receiving directions are not substantially the same as each other, namely if at least one of the signal intensities is significantly different from another or others (NO in S28), the microprocessor 15 determines on the basis of the above mechanism that the kind of antenna connected to the tuner 11 is the smart antenna 2, and registers the smart antenna 2 as the used antenna in the antenna management file (S30).

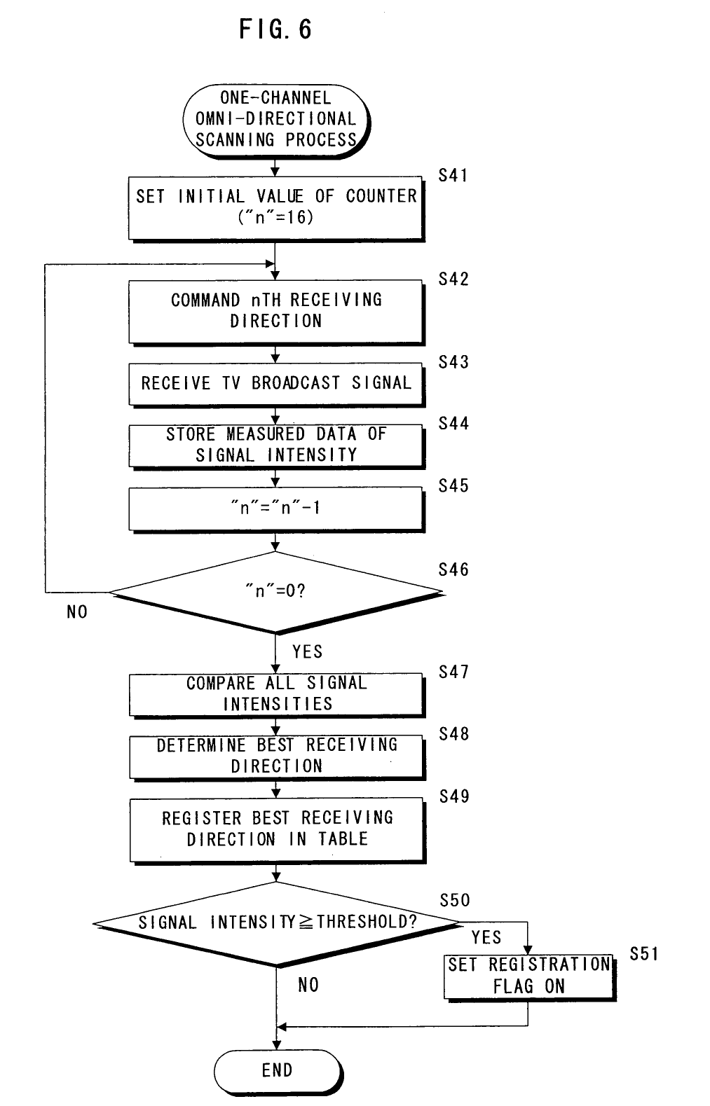

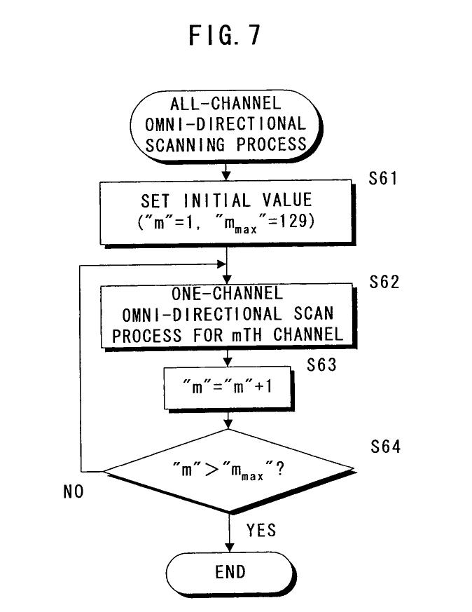

Referring now to the flow charts of FIG. 6 and FIG. 7, the following describes a one-channel omni-directional scanning process, and an all-channel omni-directional scanning process, respectively, which the TV broadcast receiver 1 performs in e.g. the step S4 of the channel information table creating process. Before the description of the all-channel omni-directional scanning process to determine best receiving directions for all the channels transmitted from broadcast stations, the one-channel omni-directional scanning process to determine a best receiving direction for one arbitrary selected channel will be described with reference to FIG. 6.

Referring to FIG. 6, when the one-channel omni-directional scanning process starts, the microprocessor 15 sets an initial value n (n being “16”) of a counter according to the number of the receiving directions D1 to D16 of the smart antenna 2 (S41). The microprocessor 15 outputs, to the smart antenna 2, a receiving direction control signal to command an nth receiving direction (S42), so that the tuner 11 receives a TV broadcast signal of the selected channel (S43). The microprocessor 15 commands the tuner 11 to measure the signal intensity of the received TV broadcast signal, and stores the measured data of signal intensity in the memory 16 (S44).

Thereafter, the microprocessor 15 decrements the counter by one (S45), and determines whether or not the tuner 11 has measured signal intensities of the received TV broadcast signal for all the receiving directions of the smart antenna 2 (S46). If the tuner 11 has not measured signal intensities of the TV broadcast signal for all the receiving directions (NO in S46), the microprocessor 15 goes back to the step S42, and commands the tuner 11 to measure the signal intensity or intensities of the TV broadcast signal not having been measured (more specifically measures the signal intensity of the TV broadcast signal for each subsequent receiving direction until completion).

If the tuner 11 completes the measurements of the signal intensities of the TV broadcast signal for all the receiving directions (YES in S46), so that the memory 16 stores all the measured data of signal intensities, the microprocessor 15 reads the measured data stored in the memory 16, and further compares all the read signal intensities (S47), so as to determine a receiving direction to give the maximum signal intensity as a best receiving direction of the received TV broadcast signal (S48), and to further register the best receiving direction for the selected channel in a channel information table designated by reference numeral 50 in FIG. 8A (S49). The microprocessor 15 furthermore determines whether or not the signal intensity of the best receiving direction is equal to or higher than a predetermined threshold value (S50). If it is equal to or higher than the predetermined threshold value (YES in S50), the microprocessor 15 sets the registration flag on for the selected channel in the channel information table 50 with reference to FIG. 8A (S51), thereby ending the process. On the other hand, if the signal intensity of the best receiving direction is lower than the predetermined threshold value (NO in S50), the microprocessor 15 does not set the registration flag on for the selected channel in the channel information table (namely maintains the off-state of registration flag), thereby ending the process.

Referring now to the flow chart of FIG. 7, the following describes an all-channel omni-directional scanning process, which the TV broadcast receiver 1 performs for determining e.g. a best receiving direction for each of all channels (all receivable channels) transmitted from all broadcast stations. When the all-channel omni-directional scanning process starts, the microprocessor 15 sets, according to the number of channels transmitted from the broadcast stations, an initial value m of a counter as well as a number mₘₐₓ of channels for each of which a best receiving direction is to be determined (S61). By performing the one-channel omni-directional scanning process described above for an mth channel, the microprocessor 15 determines a best receiving direction and registration flag (refer to FIG. 8A) for the mth channel, and registers the determined best receiving direction and registration flag in the channel information table 50 (S62).

Thereafter, the microprocessor 15 increments the counter by one (S63), and determines whether or not the microprocessor 15 itself has completed the one-channel omni-directional scanning process for each of all the channels (S64). If the microprocessor 15 has not completed the one-channel omni-directional scanning process for each of all the channels (NO in S64), the microprocessor 15 goes back to the step 62, and performs the one-channel omni-directional scanning process for the channel or channels not having been subjected to the one-channel omni-directional scanning process (more specifically performs the one-channel omni-directional scanning process for each subsequent channel until completion). If the microprocessor 15 completes the one-channel omni-directional scanning process for each of all the channels (YES in S64), the microprocessor 15 ends the process.

FIG. 8A is a view showing an example of a channel information table 50 created by the above all-channel omni-directional scanning process. The channel information table 50 stores best receiving directions (best directions) 52 and registration flags (register flags) 53 that correspond to channel numbers 51. FIG. 8B will be described separately later. In FIG. 8A and FIG. 8B, each on-state of registration flag is indicated by “ON”, while each off-state of registration flag is indicated by “OFF”. Further, respective numbers shown in the column of the best receiving directions 52 correspond to the receiving directions D1 to D16 of the smart antenna 2 shown in FIG. 3 (for example, “2” corresponding to the receiving direction D2, and “3” corresponding to the receiving direction D3).

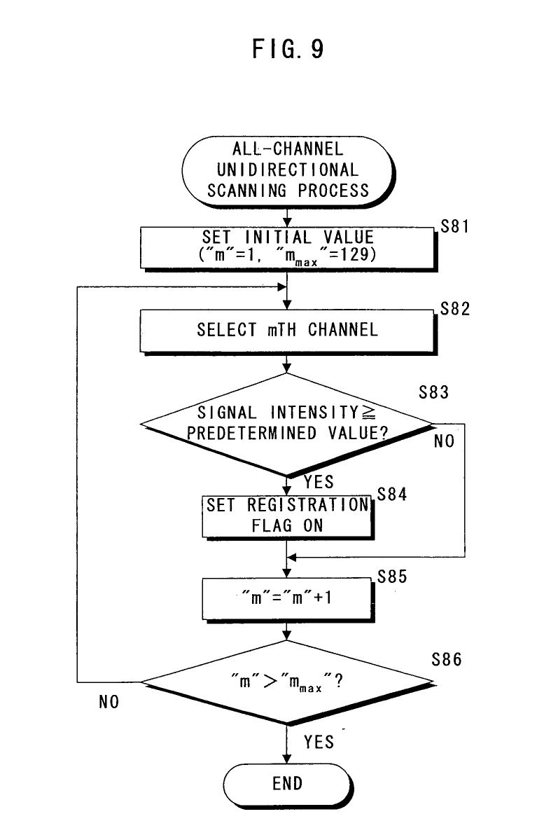

Now, referring to the flow chart of FIG. 9, the following describes an all-channel unidirectional scanning process which the TV broadcast receiver 1 performs in e.g. the step S5 of the channel information table creating process. When the all-channel unidirectional scanning process starts, the microprocessor 15 sets, according to the number of channels transmitted from the broadcast stations, an initial value m of a counter as well as a number mₘₐₓ of channels for each of which on-state/off-state of registration flag 62 is to be determined (S81). By selecting an mth channel (S82), and commanding the tuner 11 to measure signal intensity of a TV broadcast signal received by the tuner 11 for the selected channel, the microprocessor 15 determines whether or not the signal intensity is equal to or higher than a predetermined value (S83). If the signal intensity of the received TV broadcast signal is equal to or higher than the predetermined value (YES in S83), the microprocessor 15 sets the registration flag 62 on for the selected channel in a channel information table designated by reference numeral 60 in FIG. 8B (S84). On the other hand, if the signal intensity of the received TV broadcast signal is lower than the predetermined value (NO in S83), the microprocessor 15 does not set the registration flag 62 on for the selected channel, and maintains the off-state of registration flag 62 in the channel information table 60.

Thereafter, the microprocessor 15 increments the counter by one (S85), and determines whether or not the microprocessor 15 itself has completed the setting of the on-state/off-state of registration flag 62 for all the channels (S86). If the microprocessor 15 has not completed the setting of the on-state/off-state of registration flag 62 for all the channels (NO in S86), the microprocessor 15 goes back to the step S82, and sets on-state or off-state for the channel or channels not having been set with respect to the on-state/off-state of registration flag 62 (more specifically sets on-state or off-state for each subsequent channel until completion). If the microprocessor 15 completes the setting of the on-state/off-state of registration flag 62 for all the channels (YES in S86), the microprocessor 15 ends the process.

FIG. 8B is a view showing an example of a channel information table 60 created by the above all-channel unidirectional scanning process. The channel information table 60 stores registration flags 62 that correspond to channel numbers 61.

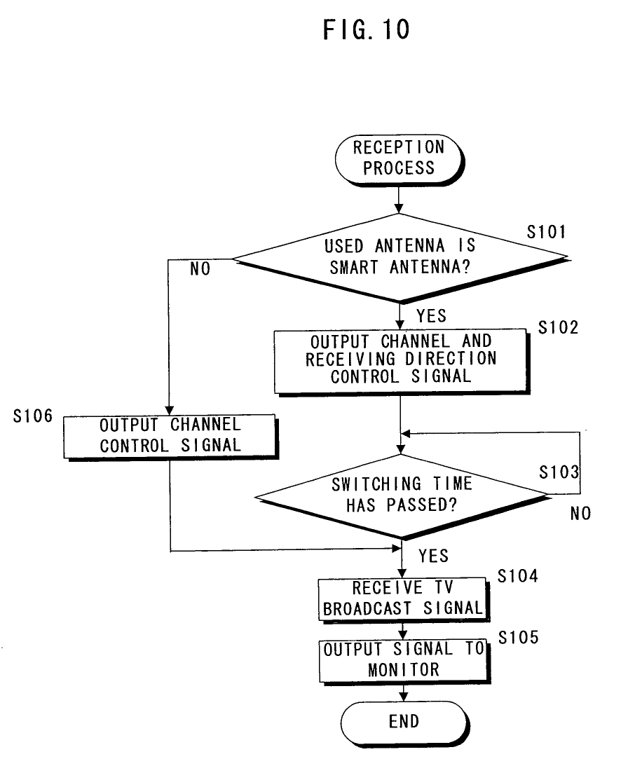

Referring now to the flow chart of FIG. 10, the following describes a reception process which the TV broadcast receiver 1 performs for receiving a TV broadcast signal when a channel to view is selected and input by a user. When a user selects and inputs a channel to view, the microprocessor 15 references the antenna management file so as to determine whether or not the used antenna is a smart antenna 2 (S101). If the used antenna is a smart antenna 2 (YES in S101), the microprocessor 15 outputs a channel control signal and a receiving direction control signal (S102), and determines whether a predetermined receiving direction switching time has passed (S103). After the predetermined receiving direction switching time (YES in S103), the microprocessor 15 commands the tuner 11 to receive a TV broadcast signal of the selected channel (S104), and outputs the TV broadcast signal to the monitor 3 (S105), thereby ending the reception process.

On the other hand, if the used antenna is not a smart antenna 2, namely, is a unidirectional antenna 21B (NO in S101), the microprocessor 15 outputs a channel control signal alone (S106), and commands the tuner 11 to receive a TV broadcast signal of the selected channel (S104), and further outputs the TV broadcast signal to the monitor 3 (S105), thereby ending the reception process. Thus, the microprocessor 15 starts commanding the tuner 11 to receive the TV broadcast signal without waiting for the receiving direction switching time, because it is not necessary (it is not possible) to switch the receiving direction of the antenna, if the used antenna is a unidirectional antenna.

As described in the foregoing, the TV broadcast receiver 1 according to the present embodiment performs the antenna discrimination process so as to determine the kind of antenna connected to the tuner 11, as to whether it is a unidirectional antenna 21B or a smart antenna 2. If the TV broadcast receiver 1 determines that the antenna connected to the tuner 11 is a unidirectional antenna 21B, which is incapable of changing its receiving direction or directivity, only a channel control signal is output to control the reception process of the TV broadcast receiver 1 for receiving a TV broadcast signal. On the other hand, if the TV broadcast receiver 1 determines that the antenna connected to the tuner 11 is a smart antenna 2, both a channel control signal and a receiving direction control signal are output to control the reception process of the TV broadcast receiver 1 for receiving a TV broadcast signal. Thus, depending on the kind of the connected antenna, the TV broadcast receiver 1 can properly perform its TV broadcast signal reception processes.

It is to be noted that the present invention is not limited to the above embodiments, and various modifications are possible. For example, the TV broadcast signals which the TV broadcast receiver 1 can receive are not limited to digital television broadcast signals, but can be analog television broadcast signals. Furthermore, the number of receiving directions of the smart antenna 2 is not limited to sixteen as exemplified in the above embodiments, but can be another number such as four or eight.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2004-201707 filed Jul. 8, 2004, the contents of which are hereby incorporated by reference.

What is claimed is:

1. A television broadcast receiver comprising:
a tuner connected to a unidirectional antenna having a single receiving direction, or to a multi-directional antenna having a predetermined number of receiving directions, for receiving a television broadcast signal; and
a microprocessor for controlling a reception process of the television broadcast receiver to receive the television broadcast signal,
wherein for performing the reception process of the television broadcast receiver, the microprocessor outputs, to the multi-directional antenna or the unidirectional antenna, a receiving direction control signal for commanding a receiving direction to receive the television broadcast signal, and determines, on the basis of signal intensities of the television broadcast signal received by the tuner, whether the unidirectional antenna or the multi-directional antenna is connected to the tuner, and
wherein if the microprocessor determines that the unidirectional antenna is connected to the tuner, the microprocessor controls to output, to the tuner, a channel control signal to command the tuner for a channel to be selected, while if the microprocessor determines that the multi-directional antenna is connected to the tuner, the microprocessor controls to output, to the tuner, the channel control signal and the receiving direction control signal.

2. The television broadcast receiver according to claim 1,
wherein the microprocessor sequentially outputs, to the multi-directional antenna or the unidirectional antenna, the receiving direction control signal to sequentially command receiving directions of the multi-directional antenna, and further commands the tuner to measure signal intensities of the received television broadcast signal which correspond to the respective receiving directions, and
wherein if the measured signal intensities corresponding to the respective receiving directions are substantially the same as each other, the microprocessor determines that the unidirectional antenna is connected to the tuner, while if at least one of the measured signal intensities is significantly different from another or others, the microprocessor determines that the multi-directional antenna is connected to the tuner.

3. The television broadcast receiver according to claim 2, wherein the number of receiving directions of the multi-directional antenna is sixteen.

4. A television broadcast receiver comprising:
a signal receiving means connected to a unidirectional antenna having a single receiving direction, or to a multi-directional antenna having a predetermined number of receiving directions, for receiving a television broadcast signal; and
a reception control means for controlling a reception process of the television broadcast receiver to receive the television broadcast signal,
wherein for performing the reception process of the television broadcast receiver, the reception control means outputs, to the multi-directional antenna or the unidirectional antenna, a receiving direction control signal for commanding a receiving direction to receive the television broadcast signal, and determines, on the basis of signal intensities of the television broadcast signal received by the signal receiving means, whether the unidirectional antenna or the multi-directional antenna is connected to the signal receiving means, and
wherein if the reception control means determines that the unidirectional antenna is connected to the signal receiving means, the reception control means controls to output, to the signal receiving means, a channel control signal to command the signal receiving means for a channel to be selected, while if the reception control means determines that the multi-directional antenna is connected to the signal receiving means, the reception control means controls to output, to the signal receiving means, the channel control signal and the receiving direction control signal.

5. The television broadcast receiver according to claim 4,
wherein the reception control means sequentially outputs, to the multi-directional antenna or the unidirectional antenna, the receiving direction control signal to sequentially command receiving directions of the multi-directional antenna, and further commands the signal receiving means to measure signal intensities of the received television broadcast signal which correspond to the respective receiving directions, and
wherein if the measured signal intensities corresponding to the respective receiving directions are substantially the same as each other, the reception control means determines that the unidirectional antenna is connected to the signal receiving means, while if at least one of the measured signal intensities is significantly different from another or others, the reception control means determines that the multi-directional antenna is connected to the signal receiving means.

6. The television broadcast receiver according to claim 5, wherein the number of receiving directions of the multi-directional antenna is sixteen.
